(19) United States
(12) Patent Application Publication
(10) Pub. No.: US 2024/0354814 A1
(43) Pub. Date: Oct. 24, 2024

(54) INTERNET SEARCH AND USER INTERFACE

(71) Applicant: Roy Lee Marks, Sr., McKeesport, PA (US)

(72) Inventor: Roy Lee Marks, Sr., McKeesport, PA (US)

(21) Appl. No.: 18/687,194

(22) PCT Filed: Aug. 29, 2022
(86) PCT No.: PCT/US2022/041813

§ 371 Date: Feb. 27, 2024

Related U.S. Application Data
(60) Provisional application No. 63/273,180, filed on Oct. 29, 2021.
(60) Provisional application No. 63/237,786, filed on Aug. 27, 2021.

(51) Int. Cl. G06Q 30/0241; G06F 16/9535; G06F 16/9538

(52) U.S. Cl. CPC G06Q 30/0277; G06F 16/9535; G06F 16/9538

(57) ABSTRACT

Internet searching and displaying internet search results in a graphical user interface.

### CROSS REFERENCE TO RELATED APPLICATIONS

This application claims the benefit of U.S. Provisional Patent Application Ser. No. 63/273,180, filed Oct. 29, 2021, and U.S. Provisional Patent Application Ser. No. 63/237,786, filed Aug. 27, 2021, the contents of which are incorporated herein in their entirety.

### BACKGROUND OF THE INVENTION

This invention relates to internet searching, and more particularly to searching and displaying internet search results.

Internet search engines are commonly employed for finding information based on keyword searching. The search results seen by the person doing the search may depend upon payments made to search engine providers, which change the ranking of a particular search result relative to other search results based in part on the keywords entered into the search. Typically, search results are included in a text-based list of web pages that allow a user to select which pages to select to find the results one is looking for. Such a search process and the presentation of the results may be less than optimal for the person conducting the keyword search and companies wishing to spend advertising money to direct those conducting keyword searches to the companies' websites.

### SUMMARY OF THE INVENTION

According to an aspect, the invention may provide a method for presenting advertising along with organic keyword search results.

According to an aspect, the invention may provide a graphical user interface for displaying search results from a search through an internet search engine.

According to an aspect, the invention may provide a method for presenting unrelated paid advertisements, along with top ranked internet apps and services, in a graphic interface that supports a top keyword search.

According to an aspect, the invention may provide a non-transitory computer readable program instructions, the non-transitory computer readable program instructions, when read by one or more processors, causes the one or more processors to execute operations comprising: embedding, or directing embedding of, at least one top keyword search term in a target website, which website is available for an internet search engine to access, which embedding induces the internet search engine to list the target website on an internet search result page; guiding, or directing guiding of, an internet browser to open the target website upon selection of the target website from the internet search result page; and displaying, or directing displaying of, the target website with a link to the at least one top keyword search term in a graphical user interface occupying a portion of the graphical user interface, with other information unrelated to the at least one top keyword search term displayed in a different portion of the graphical user interface.

According to an aspect, the invention may provide a non-transitory computer readable program instructions, the non-transitory computer readable program instructions, when read by one or more processors, causes the one or more processors to execute operations comprising: displaying, or directing display of, a target internet search page, which search page includes a center frame displaying an item in a middle portion of a graphical user interface and a plurality of other items, each displayed in a carrousel of other frames surrounding the center frame; and providing, or directing providing of, a link in each of the plurality of the other items such that when the link in one of the plurality of other items is selected, the one of the plurality of other items is displayed in the center frame in place of the item that was previously displayed in the center frame.

Various aspects of this invention will become apparent to those skilled in the art from the following detailed description of the preferred embodiments, when read in light of the accompanying drawings.

### BRIEF DESCRIPTION OF THE DRAWINGS

FIG. 1 is a schematic view of a user interface for a search engine.

FIG. 2 is a schematic view of a user interface for a search engine.

FIG. 3 is a schematic view of a user interface for a search engine.

FIG. 4 is a schematic view of a user interface for a search engine.

FIG. 5 is a schematic view of a user interface.

FIG. 6 is a schematic view of a user interface.

FIG. 7 is a schematic view of a user interface.

FIG. 8 is a schematic view of internet connectivity.

FIG. 9 is a schematic view of a user interface.

FIG. 10 is a schematic view of a user interface.

FIG. 11 is a schematic view of a user interface.

FIG. 12 is a schematic view of a user interface.

FIG. 13 is a schematic view of a user interface.

FIG. 14 is a schematic view of a user interface.

FIG. 15 is a schematic view of a user interface.

FIG. 16 is a schematic view of a user interface.

FIG. 17 is a schematic view of a user interface.

FIG. 18 is a schematic view of a user interface.

FIG. 19 is a schematic view of a user interface.

FIG. 20 is a schematic view of a user interface.

FIG. 21 is a schematic view of a user interface.

### DETAILED DESCRIPTION OF THE PREFERRED EMBODIMENTS

Electronic devices connectable to the internet may employ a search engine that is accessible via an internet search page (or portion of an internet page) displayed with an internet browser application. The internet search user interface may be generated by operating systems running a particular device that accesses the internet. The particular device displaying the user interface may be a mobile device (e.g., a cell phone, a tablet, a laptop computer, a watch, virtual reality goggles, or an interface screen in a vehicle) or may be a stationary device (e.g., a desktop computer, a television with internet connection, or a household appliance). A user may input a search term using various types of input mechanisms (e.g., a keyboard, a touch screen, a mouse or a voice input) to the search page (or portion thereof).

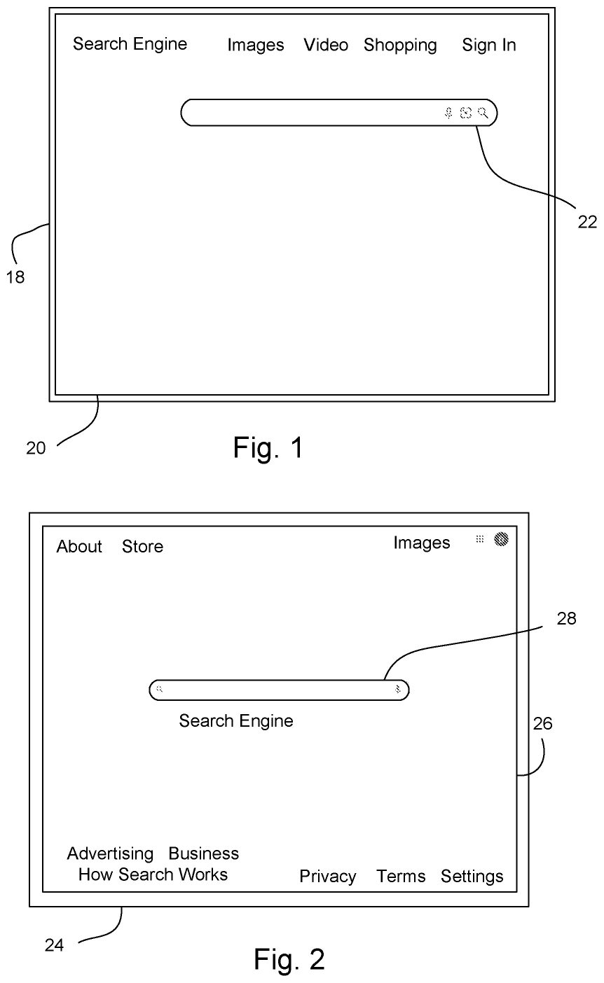

FIG. 1 illustrates an example of a user interface comprising an internet browser (e.g., Edge browser™) opened to an internet search page (e.g., Bing™, Yahoo Search™). The trademarked names used herein (in the specification and drawings) are merely for purposes of providing examples relative to the system and methods discussed herein; the trademarks are owned by their respective companies. Various internet browsers may be employed (e.g., Firefox™, Internet Explorer™, Edge™ or others). The internet search user interface may be generated by operating systems running a particular device that accesses the internet (e.g., Android™). The particular device displaying the user interface may be a mobile device (e.g., a cell phone, a tablet, a laptop computer, a watch, or an interface screen in a vehicle) or may be a stationary device (e.g., a desktop computer, a television with internet connection, or a household appliance). In FIG. 1, a browser 18, such as Edge™, may display an internet page for a search engine 20, such as Bing™, which provides a location for inputting search terms 22, such as a keyword search bar, an internet URL bar or both. A user may input a search term using various types of input mechanisms (e.g., a keyboard, a touch screen, a mouse or a voice input) to the location for inputting the search terms 22.

FIG. 2 illustrates an example, similar to FIG. 1, but illustrating a different internet browser (e.g., Chrome browser™) opened to an internet search page (e.g., Google™). In FIG. 2, a browser 24, such as Chrome™, may display an internet page for a search engine 26, such as Google™, which provides a location for inputting search terms 28, such as a keyword search bar and/or an internet URL bar.

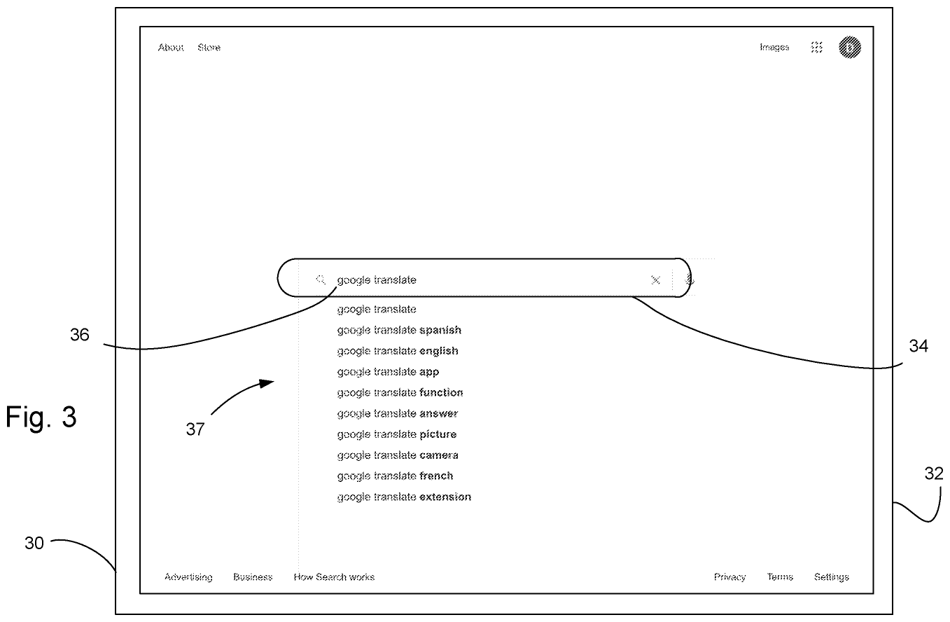

FIG. 3 illustrates an example of an internet browser (e.g., Chrome™) opened to an internet search page (e.g., Google™). One may input (e.g., via typing, touch screen, mouse or speaking) a keyword search term into, for example, a keyword search bar, which may offer a dropdown list of preselected search terms based on the entry into the keyword search bar. For the discussion of this particular example, one may enter a keyword that is one of a selected number (e.g., ten) of top keyword search terms (e.g., Google Translate™, Yahoo finance™, calculator, Facebook™, YouTube™, weather, Amazon™, Gmail™, Instagram™, etc.), in which such top keyword search terms may be relative to, for example, a particular country, region and/or worldwide. When referring to top keyword search terms, these are terms that are most often searched for by people using the particular search engine(s)—for example terms most often entered as a search by users during a recent time interval and in a particular geographic region. These top keyword search terms may be updated from time to time to include the most relevant top keyword searches by users of the search engine(s). The particular website (target website, discussed below) to which one wishes to direct web traffic will employ some or all of these top keyword search terms (e.g., as links to the internet page for the particular term searched, as metadata affiliated with the website (target website) to which one wishes to direct the web traffic, other ways to affiliate the particular top keyword search terms with the we particular website (target website) to which one wishes to direct web traffic, or a combination of these techniques) in order to be presented as a possible selection in the search results.

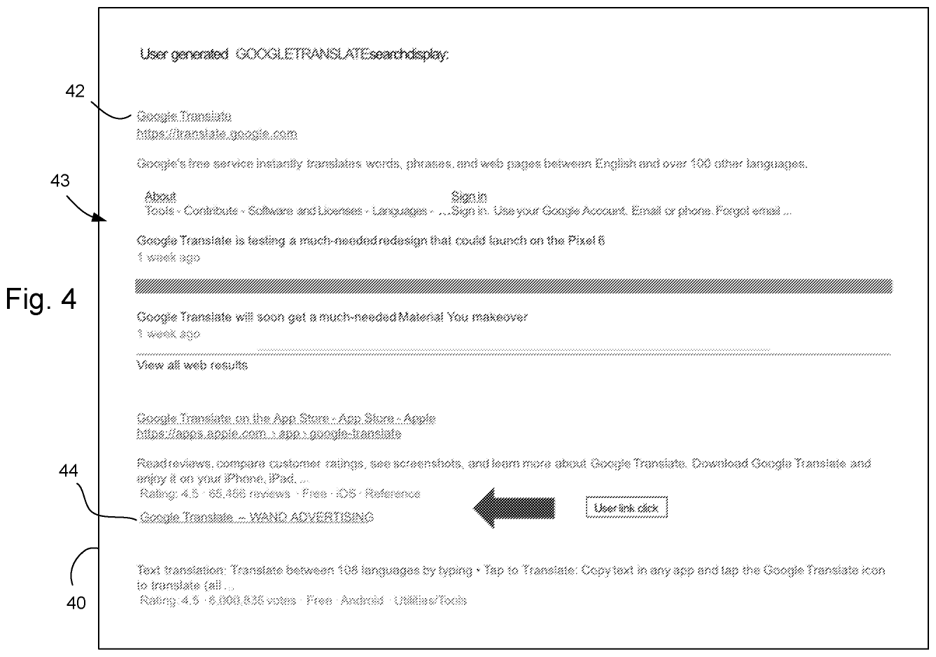

In FIG. 3, a browser 30, such as for example Chrome™, may display an internet page for a search engine 32, such as for example Google™, in which a user inputs in the keyword search bar 34 one of the top keyword search terms 36, such as for example Google Translate™, and then proceeds to conduct an internet search. While typing in the keyword search terms 36, a dropdown list 37 of possible search terms may appear on the page for the search engine 32 in the user interface. The results of such a search may be presented, for example, as shown in FIG. 4.

FIG. 4 illustrates an example of an internet browser opened to an internet search result page, which may be based on, for example, a keyword search such as the example illustrated in FIG. 3. Typically, the list of search results are based on rankings obtained through algorithms that the particular search engine employs. Since the particular website (target website) to which one wishes to direct web traffic (e.g., Wand Advertising™) employs top keyword search terms (e.g., Google Translate™), the particular website for Wand Advertising™ may appear in the ranked list of search results for that top ten keyword search term. And, since the particular website (target website, e.g., Wand Advertising™) to which one wishes to direct web traffic employs top keyword search terms (e.g., Google Translate™), such a search result (e.g., Wand Advertising™) appears often to internet users (i.e., accelerated page rank optimization by featuring the top ten keyword searches based upon view totals analytics). Additionally, since such a website (e.g., Wand Advertising™) appears among the most searched keywords, this whole web page may be brought up in the rankings (i.e., up higher on the list of search results) based on that particular search engine's search algorithms).

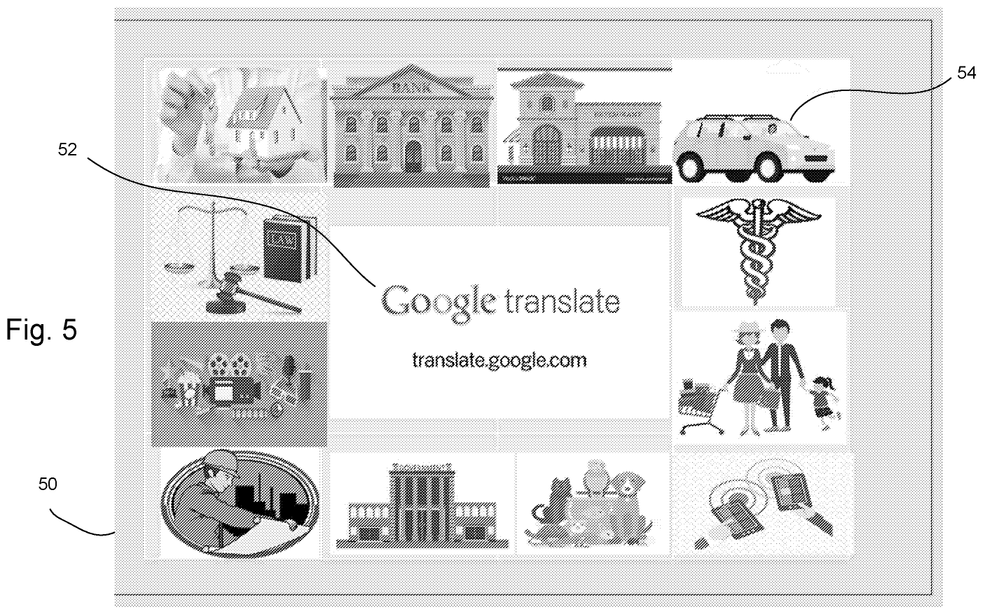

FIG. 4 illustrates an example of a user interface showing ranked search results 40 based on a top keyword search term (e.g., Google Translate™), which may direct a user to a website for that searched term through a link (URL) 42, but also shows in a ranked list 43 a link (URL) 44 to the particular website (target website, e.g., Wand Advertising™) to which one wishes to direct web traffic (e.g., Wand Advertising™). Such an appearance in the ranked 43 list may induce a user to select (e.g., click on) that particular internet link (URL) 44, which directs the user to the particular website (target website, e.g., Wand Advertising™) to which one wishes to direct web traffic (e.g., the graphical user interface of a web page as illustrated in FIG. 5). The rank for listing purposes in search results for the particular website (target website, e.g., Wand advertising™) to which one wishes to direct web traffic may also increase based on being selected due to repeatedly showing up in the lists of search results for the top keyword search terms.

FIG. 5 illustrates an example of a web page, which may have a graphical user interface (or part graphical part text-based interface), and which may be presented to a user upon selecting the link directing one to Wand Advertising™ (e.g., such as that shown as element number 44 in FIG. 4). While a text-based user interface may be employed, a graphical user interface may better assist a user in selecting desired websites. A graphical user interface may include topics and/or advertisements presented, for example, in a rectangular carousel style arrangement. Such a carousel style graphical user interface may be populated with a center advertisement/URL link that is based on the particular one of the top keyword searches that the user input in the keyword search bar (e.g., Google Translate™ as illustrated in FIGS. 3 and 4). Selecting the center graphic, then, may take the user to, for example, the Google Translate™ internet site. The carousel graphical user interface may also include a carousel of topics and/or advertisers (i.e., advertisers who paid to be included in search results) surrounding the center advertisement. Such advertisers shown may be based on, for example, a geographic location relative to a location of the user conducting the keyword search. Such outer ring of the carousel may be based on general topics/areas of interest (e.g., auto, medical, family, pets, shopping, financial, construction/repair, legal, real estate, etc.), and/or may be based on particular advertisers.

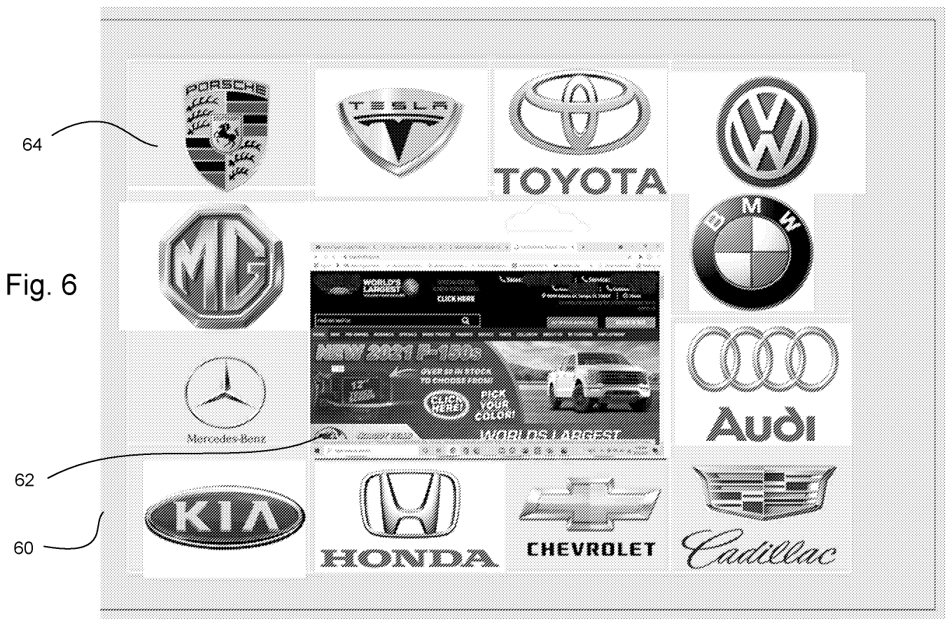

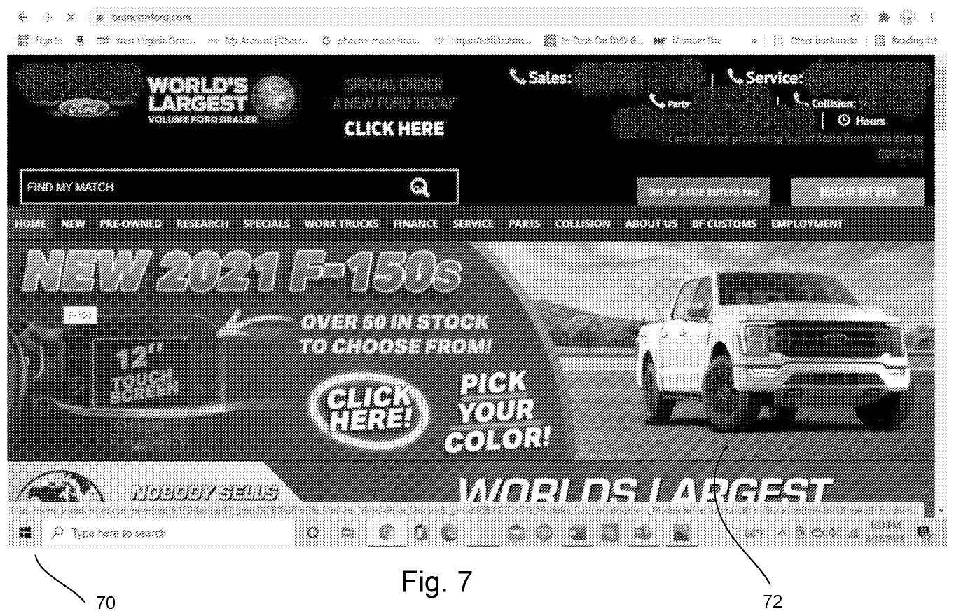

In an example shown in FIG. 5, a graphical user interface web page 50 may include a center selection 52 based on the top keyword search (e.g., Google Translate™), with a surrounding carousel of areas/topics of interest, for example, automotive 54. Upon selecting, for example, automotive 54, a new web page may appear to the user that is based on automotive advertising (as illustrated in FIG. 6).

FIG. 6 illustrates an example of a web page, which may have a graphical user interface 60 that is directed to advertisements (e.g., for paid advertisers relevant to a selection made by the user, for example that illustrated in FIG. 5). This user interface may include a center advertisement 62, which may be surrounded by a carousel of other advertisements 64. While shown in a carousel type format, the graphical user interface may take other types of graphical layouts and/or may be more of a text-based user interface, if so desired. For the example of a carousel type of arrangement, the selection of a particular advertisement from the outside of the carousel may move this selection 62 to the center of the carousel (with or without a repopulation of a new group of advertisers around the outer ring of the carousel, as illustrated in FIG. 6) or may pull up the web page for that particular advertiser (as illustrated in FIG. 7).

FIG. 7 illustrates an example of a web page 70 for a particular advertiser 72 (which may have paid to be listed in the graphical user interface, such as those shown above). Such an advertisement, then, may result from an original keyword search (e.g., Google Translate™) that may be unrelated to the specific subject matter of the advertisement for this advertiser 72.

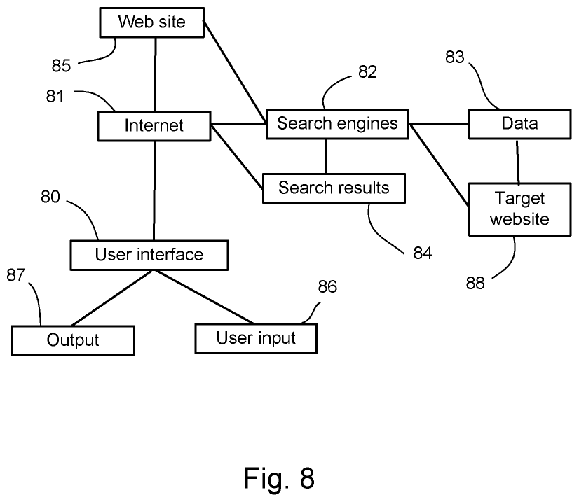

FIG. 8 illustrates a schematic view of internet connectivity. A user interface 80 (e.g., a cell phone, a tablet, a laptop computer, a watch, virtual reality goggles, an interface screen in a vehicle, a desktop computer, a television with internet connection, a household appliance with an internet connection, a personal digital assistant, a voice activated room device (e.g., Alexa™, Apple Siri™ or Google Assistant™), or any combination of these) may connected through an internet service provider 81 (e.g., wired internet, wireless internet, internet through cellular phone networks, or other connections to the internet) to one of many search engines 82 (e.g., Google™, Bing™, Yahoo™, Baidu™, DuckDuckGo™), which have access to data 83 (including the target website 88) for conducting keyword searches and a user interface for presenting results of such searches 84, and connections to websites 85 that appear in the results of such searches. The software and hardware for the devices connecting to the internet, the transmission of data through the internet, the searching through data accessible to the search engines, and returning search results, in general, are known to those skilled in the art and so will not be discussed in detail herein. The user may use an input device 86 (e.g., a keyboard, a touchscreen, a mouse, voice recognition or other means of user input) to input a search request, and an output device 87 (e.g., an electronic screen or other means of communicating output to the user) may display search results to a user.

The target website 88 may be hosted on a server or other type of electronic device that may include a processing unit. The processing unit can execute a sequence of machine-readable instructions, which can be embodied in a program or software. The instructions may be stored in a memory location. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. The storage unit can store files, such as drivers, libraries and saved programs. In some cases, the computer system can include one or more additional data storage units that are external to the computer system, such as located on a remote server that is in communication with the computer system through an intranet or the Internet. The code can be pre-compiled and configured for use with a machine have a processer adapted to execute the code or can be compiled during runtime. The code can be supplied in a programming language that can be selected to enable the code to execute in a pre-compiled or as-compiled fashion. In some embodiments, the processor comprises a code. The code can be program instructions. In one or more aspects, one or more of the functions described herein may be implemented in hardware, digital electronic circuitry, analog electronic circuitry, computer software, firmware, including the structures disclosed in this specification and their structural equivalents thereof, or in any combination thereof. Certain implementations of the subject matter described in this document also can be implemented as one or more controllers, computer programs, or physical structures, for example, one or more modules of computer program instructions, encoded on a computer storage media for execution by, or to control the operation of window controllers, network controllers, and/or antenna controllers. Any disclosed implementations presented as or for electrochromic windows can be more generally implemented as or for switchable optical devices.

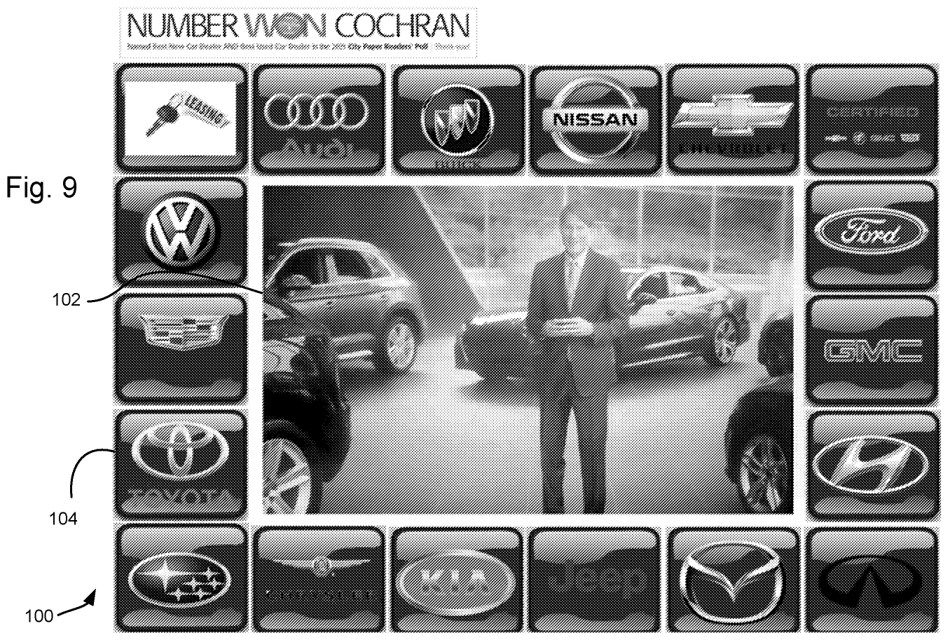

FIG. 9 illustrates an example of a web page, which may have a graphical user interface 100 that is directed to advertisements (which may be for paid advertisers relevant to a selection made by the user). This user interface may include a center frame (e.g., advertisement, inventory, topics, services, site access, etc.) 102, which may be surrounded by a carousel of other frames (e.g., advertisements, inventory, topics, services, etc.) (also called a carousel herein) 104. For a particular advertiser, the center frame 102 may automatically (or at the user's choice) play a video advertisement, which may have video motion, sound or both. The center frame 102 for some advertisers may be a still image, with or without text.

Additionally, for this particular example of a graphical user interface 100, and the other similar graphical user interfaces disclosed herein, the center frame (e.g., advertisement, link, web page, etc.) 102, the carousel 104 or both may provide various combinations of animations to attract the user to the information on the user interface 100. The graphical user interface 100 may, for example. Employ fade-in or fade-out, random appearance, directional movement, size and/or shape morphing, or combinations of these animations for various portions of the interface. Additional examples for presentation options for the graphical user interface 100 may comprise cascading parts of the user interface that assemble into the complete user interface 100.

Moreover, for this particular example of a graphical user interface 100, and the other similar graphical user interfaces disclosed herein, while the figures generally show a rectangular central frame 102 and rectangular carousel 104, the geometry of the individual elements, as well as the overall view, may be circular, oval, triangular or other shapes. Also, the central frame may include one block or multiple blocks with different information in each block, and the carousel may include various numbers and sizes of blocks, which may include different information in each block.

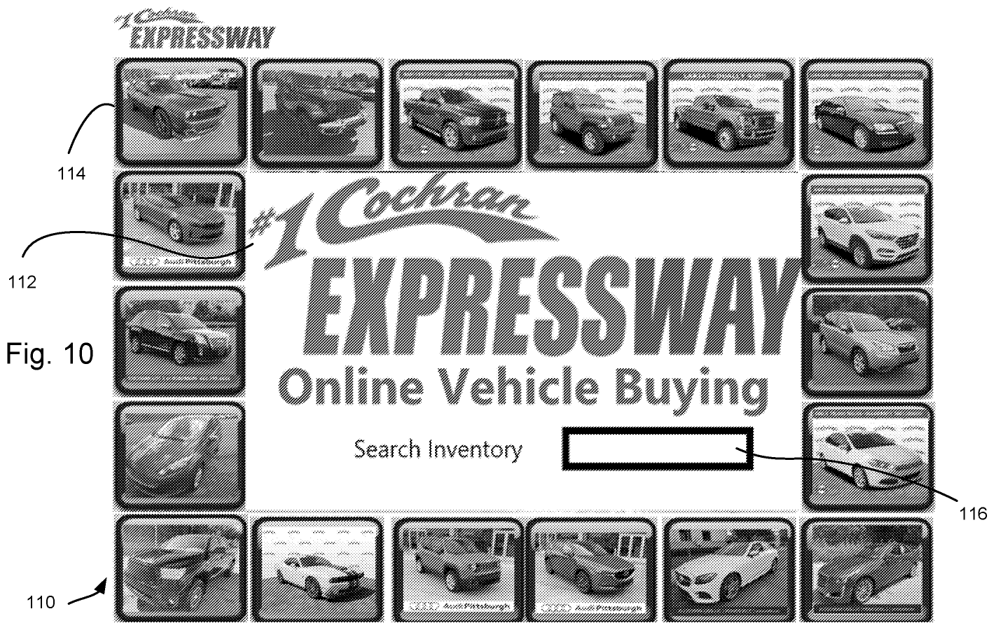

FIG. 10 illustrates an example of a web page, which may have a graphical user interface 110 that is directed to, for example, advertisements relevant to a selection made by the user. This user interface may include a center advertisement (e.g., for a particular internet seller, such as a vehicle dealer) 112, which may be surrounded by a carousel 114 of some of the current inventory (e.g., available vehicles) for this internet seller. The center advertisement 112 may also include an inventory search function 116, allowing a user to search for a particular item or items within this internet seller's current inventory. The internet search function may be a search functionality built into the internet seller's website, or may be a general search functionality (e.g., from a generally used internet search engine directing the search to this particular website). When a user conducts such a search using the inventory search function 116, the search results may be presented in the center advertisement 112, the carrousel 114, both the center advertisement 112 and the carrousel 114, or in another format.

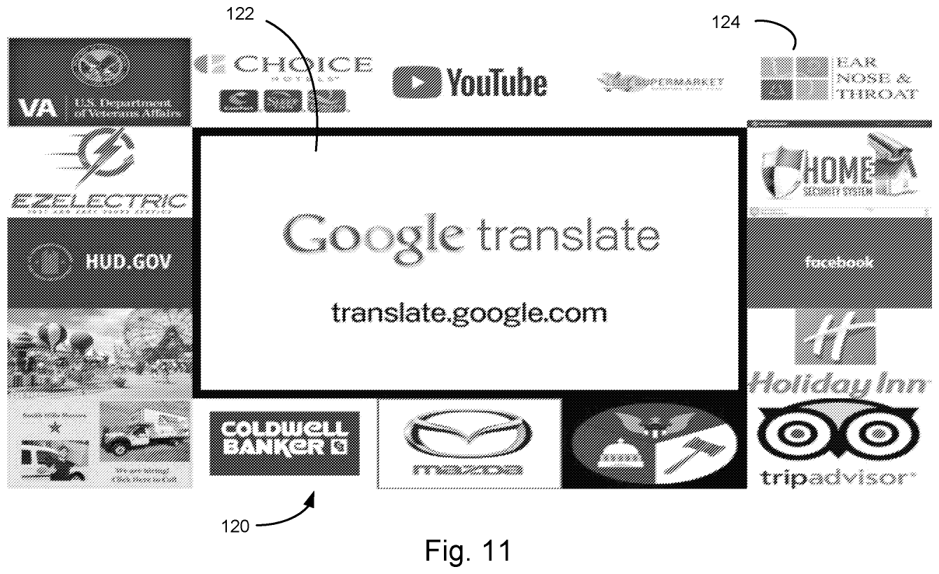

FIG. 11 illustrates an example of a web page, which may have a graphical user interface 120 that is directed to, for example, embedded software (which may be responsive, for example, to the user keyword search) in the center frame 122. The embedded software may allow a user to interact with other popular websites (e.g., top keyword search terms (e.g., Google Translate™, Yahoo finance™, calculator, Facebook™, YouTube™, weather, Amazon™, Gmail™, Instagram™, etc.) in the present example Google Translate™), with the carousel 124 displaying other advertisements, topics of interest, etc. The embedded software may include, for example, Google Translate™, news updates, weather forecasts, job searches, etc.

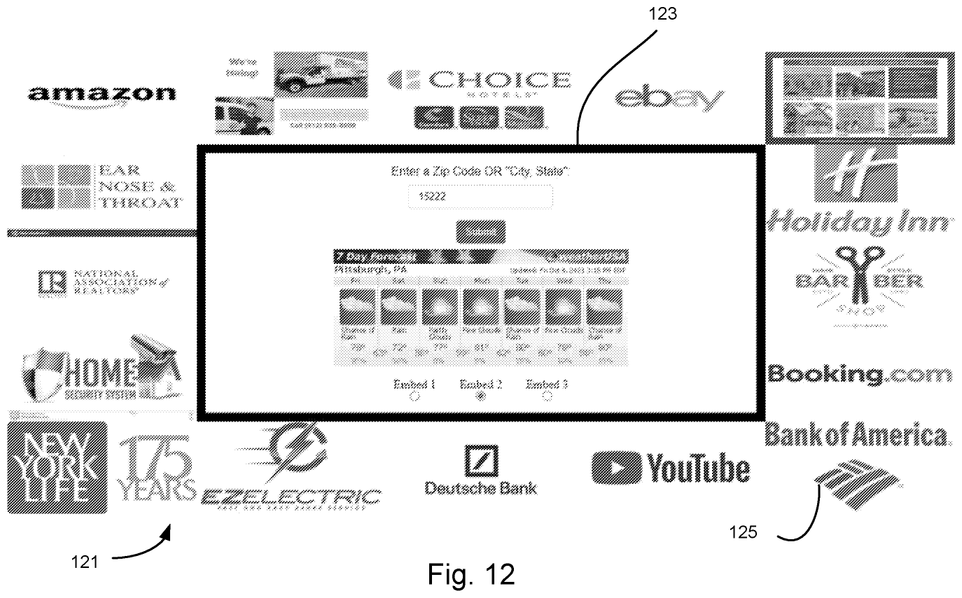

FIG. 12 illustrates an example of a web page, which may have a graphical user interface 121 that is directed to, for example, embedded software (which may be responsive to the user keyword search) in the center frame 123. The embedded software may allow a user to interact with other popular websites (e.g., top keyword search terms (e.g., Google Translate™, Yahoo finance™, calculator, Facebook™, YouTube™, weather, Amazon™, Gmail™, Instagram™, etc.) in the present example local weather forecast), with the carousel 125 displaying other advertisements, topics of interest, etc. The embedded software may include, for example, news updates, weather forecasts, job searches, etc.

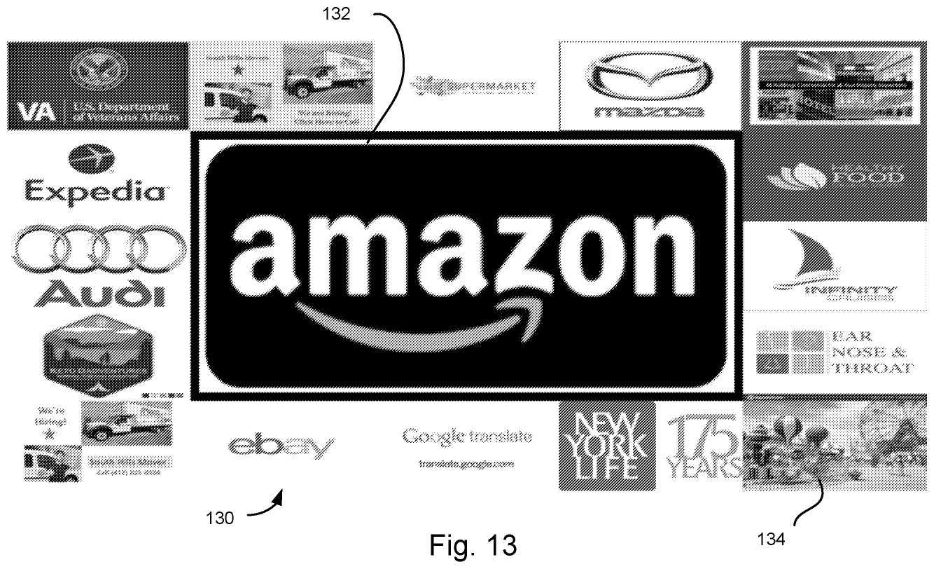

FIG. 13 illustrates an example of a web page, which may have a graphical user interface 130 that is directed to, for example, click-through hyperlinks (which hyperlinks may be responsive to the user keyword search) in the center frame 132 for direct access to the particular website(s) (in the present example Amazon™), which may also comprise embedded software. The carousel 134 may display advertisements, topics of interest, etc. The hyperlinks may include, for example, Amazon™, Facebook™, YouTube™, a weather forecast for a particular weather news service, Gmail™, Instagram™, etc.

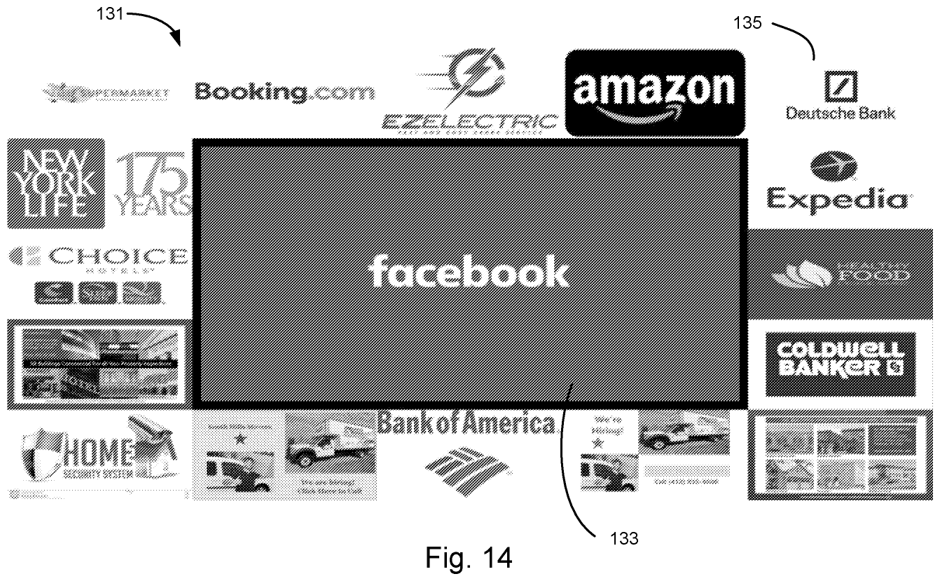

FIG. 14 illustrates an example of a web page, which may have a graphical user interface 131 that is directed to, for example, click-through hyperlinks (which hyperlinks may be responsive to the user keyword search) in the center frame 133 for direct access to the particular website(s) (in the present example Facebook™), which may also comprise embedded software. The carousel 135 may display advertisements, topics of interest, etc. The hyperlinks may include, for example, Amazon™, Facebook™, YouTube™, a weather forecast for a particular weather news service, Gmail™, Instagram™, etc.

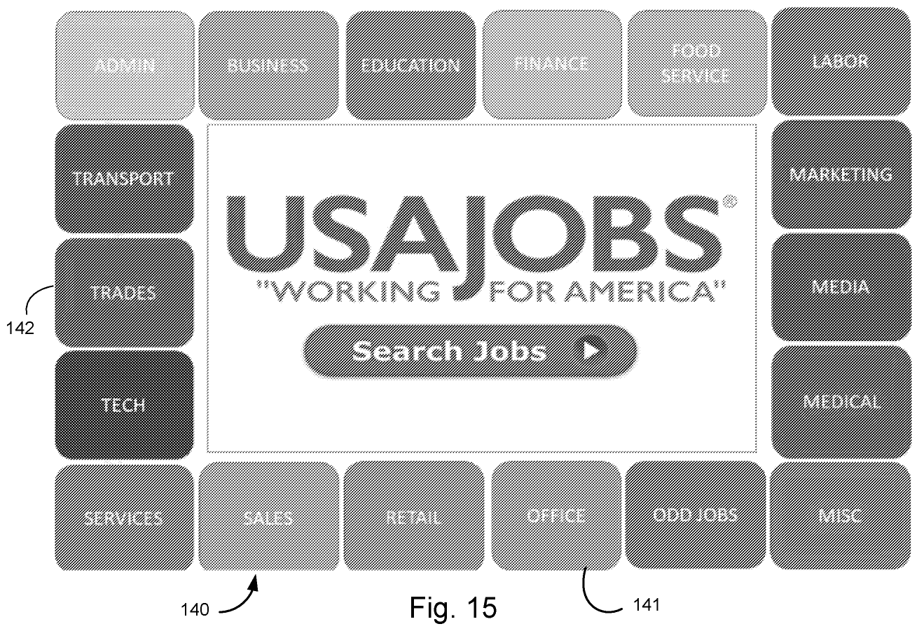

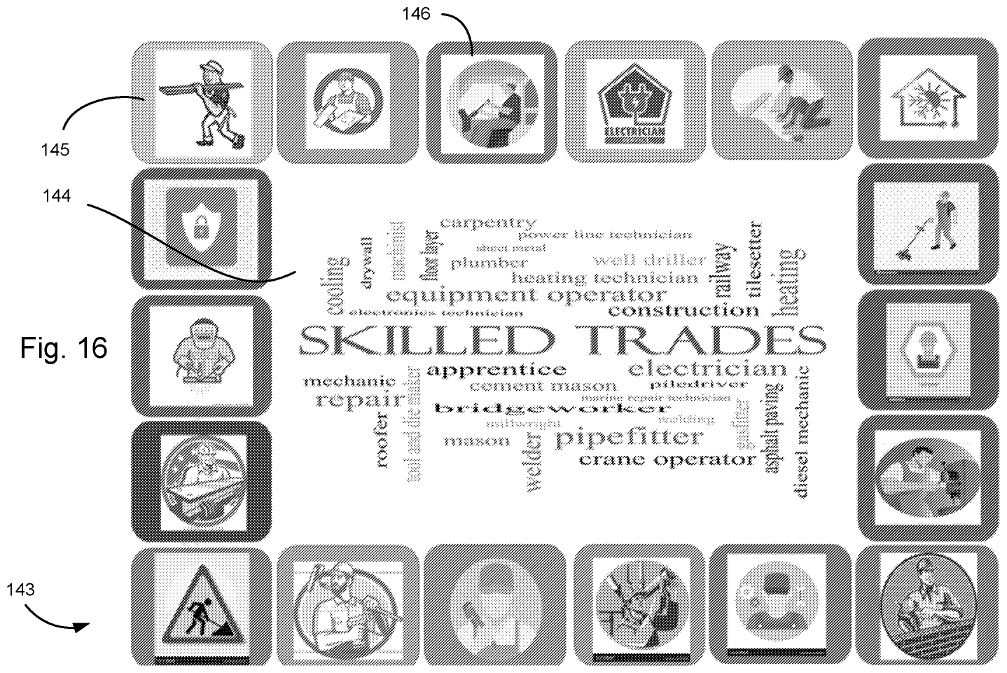

FIG. 15 illustrates an example of a web page that relates to a particular service category. For example, a graphical user interface 140 that relates to an advertisement (or the service topic) of interest to a user, is illustrated in FIG. 15. A carousel 141 may provide, for example, text-based listings of types of jobs. A user selecting, for example, trades 142, may change the graphical user interface to job listings/options related to trades type of jobs (discussed relative to FIG. 16).

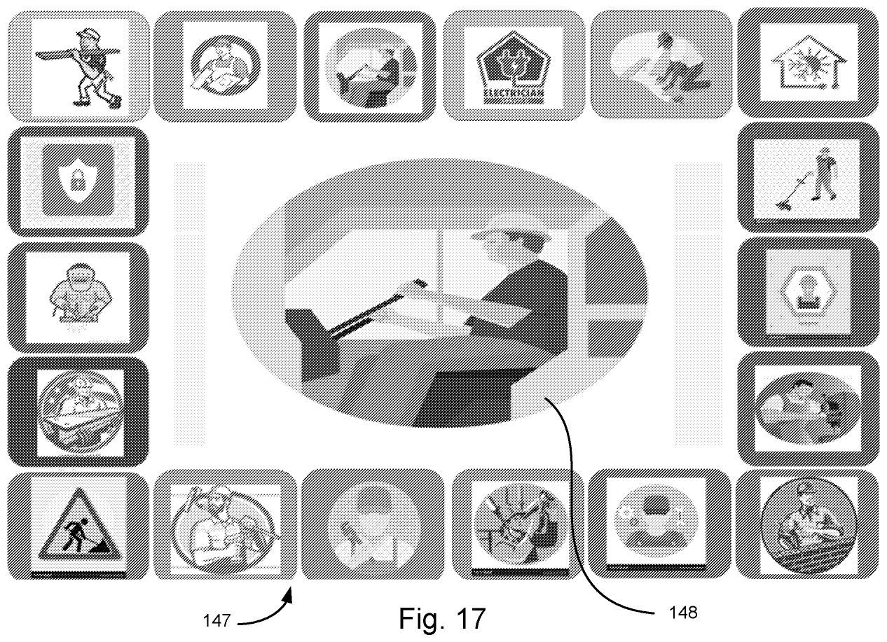

FIG. 16 illustrates an example of web page that relates to a particular job listing category (e.g., from a user search for available jobs being advertised). Upon a user selecting, for example, trades (FIG. 15), the graphical user interface 143 may change to a center frame 144 relating to skilled trades jobs, with a carousel 145 having graphical symbols indicating various types of skill trades job categories. The categories in the carousel 145 may be graphical images or may be text-based listings of job types. A user selecting, for example, a heavy machine operator symbol 146, may change the graphical user interface to job listing related to job listings/options related to heavy machine types of jobs (discussed relative to FIG. 17).

FIG. 17 illustrates an example of a web page that relates to a particular type of job category (e.g., a job search for available jobs). Upon a user selecting, for example, a heavy machine operator symbol (FIG. 16), the graphical user interface 147 may change to a center frame 148 relating to a heavy machine operator.

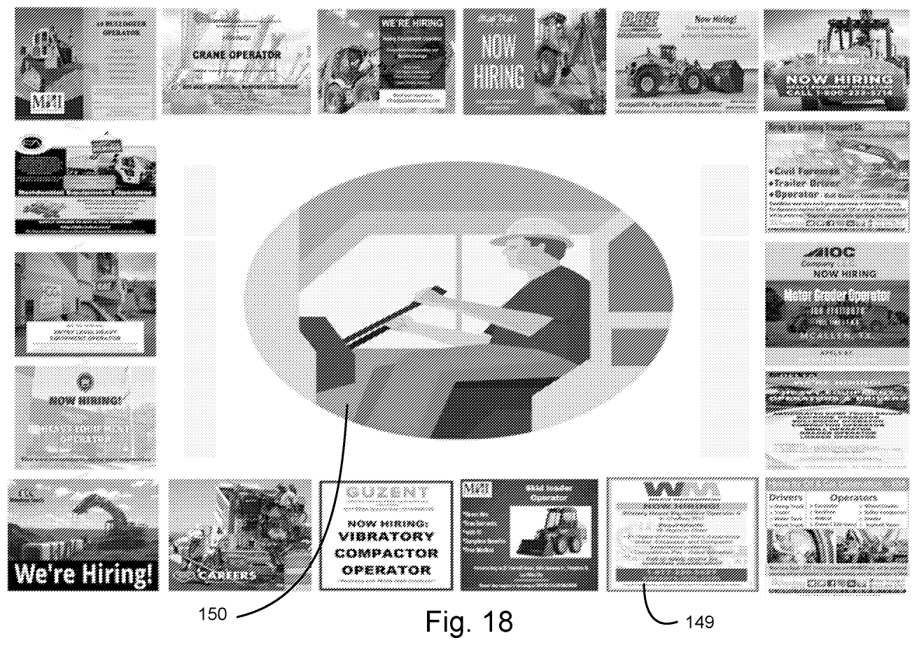

The carousel 149 may be populated with current positions available for a heavy machine operator 150, as illustrated in FIG. 18. Clicking on one of the positions available, as shown in FIG. 18, may move this advertisement to the center frame 150 or pull up the web page for the particular entity that has the available job.

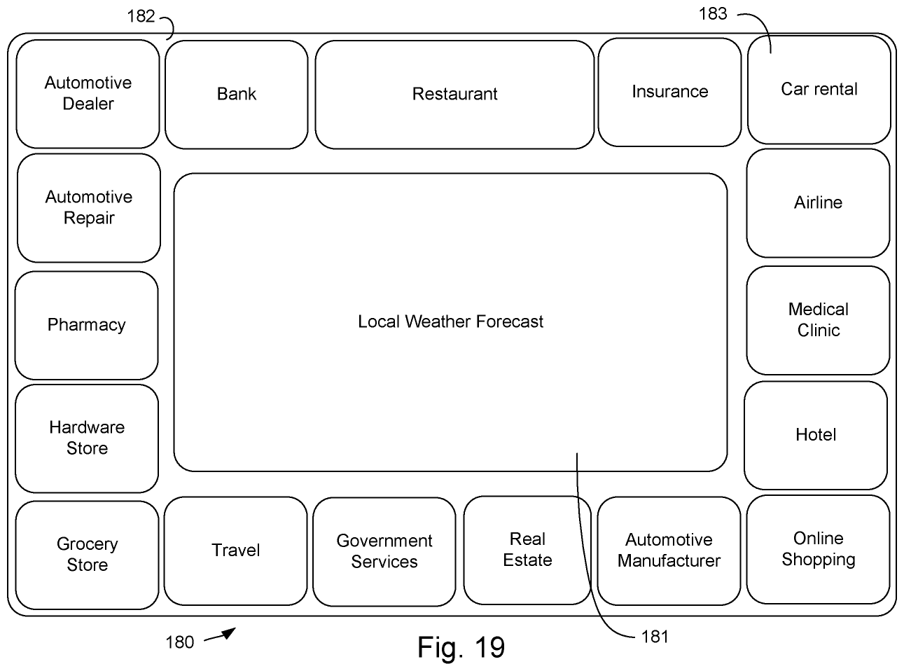

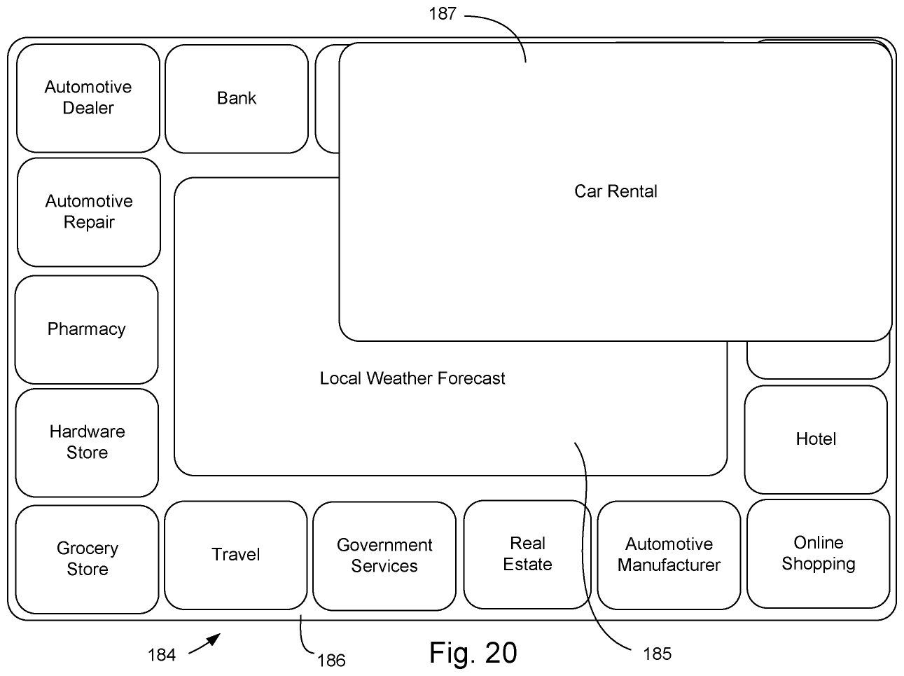

FIG. 19 illustrates an example of a web page, which may have a graphical user interface 180 that is directed to, for example, embedded software (which may be responsive to the user keyword search) in the center frame 181. The embedded software may allow a user to interact with other popular websites (e.g., top keyword search terms (e.g., Google Translate™, Yahoo finance™, calculator, Facebook™, YouTube™, weather, Amazon™, Gmail™, Instagram™, etc.) in the present example local weather forecast), with the carousel 182 displaying other advertisements, topics of interest, etc. The embedded software may include, for example, news updates, weather forecasts, job searches, etc. The size of the various advertisements/items in the carousel 182 may be the same size or may be different sizes, where the cost for advertising may vary based on the size of the particular advertisement/item in the carrousel 182. The carrousel 182 may be configured graphically to not overlap or impinge upon the center frame 181 unless a user takes a predetermined action to indicate an interest in one of the advertisements/items in the carrousel 182. For example, if the user is interested in a car rental item 183 from the carrousel (discussed relative to FIG. 20).

In FIG. 20 a user may indicate an interest in a car rental item from the carrousel (FIG. 19). Upon a user indicating an interest (e.g., hover over with a mouse pointer, actuate the area on a touch screen, move a cursor over the item with a keyboard, or other means for a user to indicate an interest) in an item 187 of the carrousel 186 in the graphical user interface 184, the item 187 on the carrousel 186 may automatically increase in size. For example, the item 187 may grow about as large as the center frame 185 but at location of the item 187 on the carrousel 186. This enlarged item 187 may display over the top of adjacent items on the carrousel 186 and at least a portion of the center frame 185.

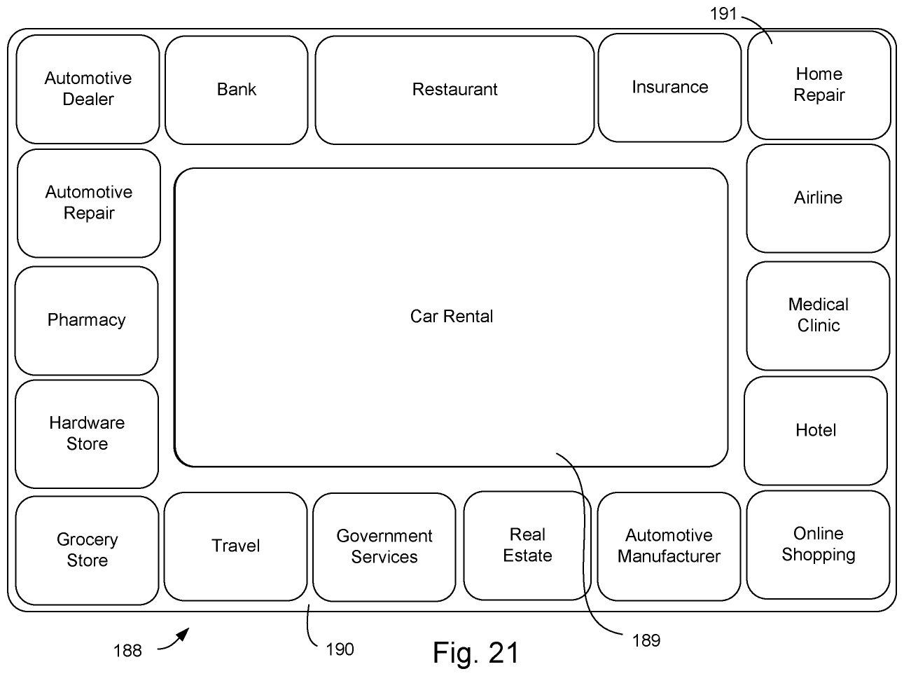

In FIG. 21 a user may indicate a request for more information regarding a car rental item from the carrousel that the user indicated an interest in (FIG. 20). Upon a user selecting (e.g., clicking on it with a mouse, indicating selection on a touch screen, hitting enter on a keyboard, or other means for a user to indicate an interest) an item (e.g., car rental), the selected item from the carrousel 190 may move to occupy the center frame 189 of the graphical user interface 188. Upon moving to the center frame 189, additional information for this item (e.g., car rental) may be displayed in the center frame 189. A new advertisement/item 191 may replace the selected item on the carrousel 190. Alternatively, when the selected item (e.g., car rental) is moved to the center frame 189, the carrousel 190 may be populated with other advertisements/items that relate to the specific topic of the new item in the center frame 189 (e.g., the carrousel advertisements/items may relate to car rental, either related to the car rental advertisement in the center frame 189 or other advertisements related to car rental but not necessarily related to the car rental advertisement in the center frame 189).

The principle and mode of operation of this invention have been explained and illustrated in its preferred embodiment. However, it must be understood that this invention may be practiced otherwise than as specifically explained and illustrated without departing from its spirit or scope.

1. A non-transitory computer readable program instructions, the non-transitory computer readable program instructions, when read by one or more processors, causes the one or more processors to execute operations comprising:
embedding, or directing embedding of, at least one top keyword search term in a target website, which target website is available for an internet search engine to access, which embedding induces the internet search engine to list the target website on an internet search result page;
guiding, or directing guiding of, an internet browser to open the target website upon selection of the target website from the internet search result page; and
displaying, or directing displaying of, the target website with a link to the at least one top keyword search term in a graphical user interface, the link occupying a portion of the graphical user interface, with other information unrelated to the at least one top keyword search term displayed in a different portion of the graphical user interface.

2. The non-transitory computer readable program instructions of claim 1 wherein the other information is at least one advertisement.

3. The non-transitory computer readable program instructions of claim 1 wherein the link to the at least one top keyword search term is displayed in a center frame of the graphical user interface and the other information is a plurality of advertisements displayed in the graphical user interface as a carrousel surrounding the center frame.

4. The non-transitory computer readable program instructions of claim 3 further comprising providing, or directing providing of, additional links in each of the plurality of advertisements such that when a corresponding on of the additional links in one of the plurality of advertisements is selected, the one of the plurality of advertisements is displayed in the center frame in place of the link to the at least one top keyword search term.

5. The non-transitory computer readable program instructions of claim 4 further comprising displaying, or directing displaying of, different information in the carrousel of the graphical user interface having information relating to a corresponding one of the additional links in the one of the plurality of advertisements that was selected.

6. The non-transitory computer readable program instructions of claim 1 wherein the at least one top keyword search term is a plurality of top keyword search terms; and
updating, or directing updating of, the plurality of top keyword search terms based on most searched for keyword search terms on the internet search engine.

7. (canceled)

8. A method of internet searching comprising:
embedding at least one top keyword search term in a target website, which target website is available for an internet search engine to access, which embedding induces the internet search engine to list the target website on an internet search result page;
guiding an internet browser to open the target website upon selection of the target website from the internet search result page; and
displaying the target website with a link to the at least one top keyword search term in a graphical user interface, the link occupying a portion of the graphical user interface, with other information unrelated to the at least one top keyword search term displayed in a different portion of the graphical user interface.

9. A non-transitory computer readable program instructions, the non-transitory computer readable program instructions, when read by one or more processors, causes the one or more processors to execute operations comprising:
displaying, or directing display of, a target internet search page, which search page includes a center frame displaying an item in a middle portion of a graphical user interface and a plurality of other items, each displayed in a carrousel of other frames surrounding the center frame; and
providing, or directing providing of, a respective additional link in each of the plurality of the other items such that when the respective additional link in one of the plurality of other items is selected, the one of the plurality of other items is displayed in the center frame in place of the item that was previously displayed in the center frame.

10. The non-transitory computer readable program instructions of claim 9 wherein the plurality of other items are advertisements.

11. The non-transitory computer readable program instructions of claim 10 further comprising displaying, or directing displaying of, different information in the carrousel of the graphical user interface having information relating to the corresponding additional link in the one of the plurality of advertisements that was selected.

12. The non-transitory computer readable program instructions of claim 9 further comprising the item displayed in the center frame automatically playing, or being directed to automatically play, a video.

13. The non-transitory computer readable program instructions of claim 9 further comprising the graphical user interface displaying, or being directed to display, the item and the other items fading-in, fading-out or both.

14. The non-transitory computer readable program instructions of claim 9 further comprising the graphical user interface displaying, or being directed to display, the item, the other items or both size and shape morphing.

15. The non-transitory computer readable program instructions of claim 9 further comprising the graphical user interface displaying, or being directed to display, the item, the other items or both having random appearances at different locations in the graphical user interface over time.

16. The non-transitory computer readable program instructions of claim 9 further comprising the graphical user interface displaying, or being directed to display, one of the other items in an enlarged size when a user indicates an interest in the one of the other items.

17. The non-transitory computer readable program instructions of claim 16 further comprising the graphical user interface displaying, or being directed to display, the one of the other items in the center frame when the user selects the one of the other items displayed in the carrousel.

18. The non-transitory computer readable program instructions of claim 17 further comprising the graphical user interface displaying, or being directed to display, a second set of other items in the carrousel when the one of the other items is selected, which second set of other items include information relating to the one of the other items selected.

19. (canceled)

20. (canceled)

21. The method of claim 8 wherein the other information is at least one advertisement.

22. The method of claim 8 wherein the link to the at least one top keyword search term is displayed in a center frame of the graphical user interface and the other information is a plurality of advertisements displayed in the graphical user interface as a carrousel surrounding the center frame.

23. The method of claim 8 wherein the at least one top keyword search term is a plurality of top keyword search terms; and further comprising:
updating the plurality of top keyword search terms based on most searched for keyword search terms on the internet search engine.
